(19) United States
(12) Patent Application Publication
(10) Pub. No.: US 2008/0280550 A1
(43) Pub. Date: Nov. 13, 2008

(54) METHOD AND APPARATUS FOR PROCESSING GIZZARDS

(75) Inventors: Charley Reed, Tontitown, AR (US); Dallas W. Prouty, Wesley, AR (US); James Ruff, Farmington, AR (US); Daniel M. Evans, Springdale, AR (US)

Correspondence Address: HUSCH BLACKWELL SANDERS LLP, 720 OLIVE STREET, SUITE 2400, ST. LOUIS, MO, 63101, US

(73) Assignee: TYSON FOODS, INC., Springdale, AR (US)

(21) Appl. No.: 12/121,075

(22) Filed: May 15, 2008

Related U.S. Application Data
(63) Continuation-in-part of application No. 11/619,185, filed on Jan. 2, 2007.

(51) Int. Cl. A22C 21/06; A22B 5/18

(52) U.S. Cl. 452/112; 452/106

(57) ABSTRACT

A method and apparatus for separating an intestine from a gizzard comprising an infeed overhead rail indexing conveyor assembly, and a dual blade cutter assembly, which teaches a novel method and apparatus for separating a substantial portion of the intestine from a gizzard with an increased yield. The steps of the process can include feeding a viscera pack into a feed end of the overhead rail system; capturing and conveying the pack with a conveyor belt or chain having indexing members along a path to engage the dual blade cutter assembly. A substantial portion of the intestine and the separated gizzard with a small portion of the intestine remaining are allowed to separate after being severed by the dual blade and fall along separate chutes for further processing.

### CROSS REFERENCE TO RELATED APPLICATION

This application is a continuation-in-part of pending U.S. patent application Ser. No. 11/619,185 filed Jan. 2, 2007, which is incorporated herein by reference in its entirety.

### BACKGROUND OF INVENTION

1. Field of Invention

This invention relates generally to poultry processing and, more particularly, to harvesting usable parts of a poultry vascular system from the viscera.

2. Background Art

Various usable parts of the vascular system are harvested from the viscera of a poultry carcass. Particularly the heart, gizzard and the liver are harvested from the viscera pack or more specifically what is generally referred to as the giblet package. The giblet package comprises the gizzard, liver, lungs, heart, intestines and vent. The natural structure of the package comprises two different kind of connections between the organs contained in the viscera. There are functional connections comprising the esophagus to the pre-stomach, the pre-stomach to the gizzard, and the gizzard to the duodenum. There is a connection between the intestine and the gizzard. The are also major membrane or fleece connections between the liver and gizzard, between the package and crop, and between the heart and liver. In the past, the separation of the usable parts such as the liver, gizzard and heart from the package was performed by a manual operation. For example, an operator would sever the connection between the liver or gizzard and further remove the intestines from the gizzard and other unusable parts such as the lungs. However, performing this operation manually is very intensive, inconsistent in quality and not cost effective. It became evident that a more automated mechanical process was needed for harvesting the usable parts of the viscera.

Various mechanical methods have been developed to isolate the liver and heart for separation by capturing certain portions of the package and utilizing the natural and membrane connections to isolate and position other portions of the package such as for example the portion containing the liver and heart. For example, previous methods have been utilized, which include the steps of mechanically stretching the viscera connected to the liver to pull the gall bladder away from the liver and mechanically cutting between the liver and the gall bladder to separate the liver from the viscera and the gall bladder. Previous methods have also included the steps of mechanically stretching the connecting structure connecting the liver to the heart to pull the heart away from the liver and mechanically cutting the connecting structure between the liver and the heart to separate the liver from the heart. Some of these types of methods include conveying poultry along a prescribed conveying path with the viscera still attached to the poultry carcass while pulling the viscera away from the liver to stretch the viscera and pull the gall bladder away from the liver; and finally separating the liver from the viscera by cutting the stretched connecting structure between the liver and the gall bladder.

This type of apparatus can be designed for use with an overhead conveyor used to transport poultry through the eviscerating section of the poultry plant with the carcass head hanging downward. A locating conveyor moving synchronously with the overhead conveyor has been utilized, where a liver positioning guide is utilized for pulling the viscera away from the liver so that the connecting structure between the gall bladder and the liver is stretched to pull the gall bladder away from the liver for separation. A heart positioning guide can be utilized, which engages the connection between the heart and the liver to selectively position the heart. A heart cutoff mechanism can be utilized to cut the heart from the liver, and a liver cutoff mechanism to cut between the liver and the gall bladder to separate the liver from the rest of the viscera. However, a system of this nature provides a poor yield, and often damages the livers.

Various methods and apparatus have been utilized to separate and isolate the usable parts including roller devices and guide devices to stretch and extend the functional and membrane connections for isolating and separating the usable parts. For example, some gizzard harvester systems utilize guide mechanisms and rollers to separate the intestine from the gizzard. However, previous methods and apparatus have resulted in a poor yield, slow yield rates resulting in line slow downs and inconsistent quality. For example gizzard harvesters utilizing rollers have to work hard and for a longer than desired duration resulting in the intestine wrapping around the rollers thereby reducing the overall efficiency and throughput rate. Further many systems require excessive maintenance and include expensive specially designed parts and mechanisms. A better system is needed considering the market demand for livers has steadily increased. In the past the amount of labor required was directly related to the ability to produce a quality product for customers. The fully automatic liver harvester systems that have been utilized do not address this issue and do not produce a consistent yield, and the maintenance and upkeep for the equipment can be very intensive. A better gizzard harvester system is also needed that solves the problem of the intestine wrapping around rollers.

By developing a simple system that consistently produces a higher yield percentage of the total available livers, a manufacture can decrease their cost and labor associated with the fully automatic system and standardize the liver harvesting system to consistently produce a higher quality product. Also, an improvement to gizzard harvester systems can improve the throughput rate with a higher quality. Therefore, the problems of significant damage to the livers, use excessive amounts of water, and specialized parts and added labor, can be resolved.

### BRIEF SUMMARY OF INVENTION

The invention is a method and apparatus for separating an intestine from a gizzard comprising an infeed overhead rail indexing conveyor assembly, and a dual blade cutter assembly, which teaches a novel method and apparatus for separating a substantial portion of the intestine from a gizzard with an increased yield. The steps of the process can include feeding a viscera pack into a feed end of the overhead rail system. Capturing and conveying the pack with a conveyor belt or chain having indexing members along a path to engage the dual blade cutter assembly. A substantial portion of the intestine and the separated gizzard with a small portion of the intestine remaining are allowed to separate after being severed by the dual blade and fall along separate chutes for further processing. Leaving a small portion of the intestine in place allows the gizzard harvester to locate and orient the gizzard properly in the harvesting machine for complete separation of the remaining small portion of the intestine from the gizzard. For example, the dual cutting blades of the present invention can severe and separate away all but a small portion of the intestine. For example, about approximately 1 to about approximately 2 inches of the intestine can remain after the dual cutting blade operation. The gizzard along with the small portion of the intestine and the remainder of the viscera pack can be feed into a chute that channels the pack to engage a pair of counter rotating pinch rollers turning into themselves and space proximately apart, such as for example about approximately 0.5 inches+/−0.1 inches. The viscera pack can be captured by the infeed conveyor of the next stage thereby forcing the package into and between the counter rollers with only the gizzard remaining on top of the roller body.

An over head indexer conveyor assembly including and an endless over head indexing feed chain or endless indexing feed belt having extending there from indexers, which engages the gizzard and pushes the viscera pack and pushes the gizzard with viscera through the length of the pinch rollers and down a set of slide rails with the gizzard sliding along the top side of the slide rails. A first module that the viscera is contacted with is a pull down bar or a pull down plate or member which pulls the pack in the area of the liver in a downwards motion away from the slide rail and gizzard retained on top of the slide rail. During this process the remaining small portion of the intestine is removed. The result is the pack membranes can be loosened and positioned in line for the next module. After moving the pack further along the slide rail proximately from the first module, for example about approximately 1 foot+/−0.1″, a second module pulls the intestine downward away from the slide rail and gizzard and pulls the intestine away from the liver. This can be accomplished by utilizing an endless pull down belt having flaps extending there from. A spinning blade can also be used remove any excess intestine from the lower liver as the pack continues on to the next module.

The pack can continue onto the final strip down module or stripper arm assembly where the liver is directed by alternate guide rails into a flighted belt with stationary top with an opening, for example about approximately 0.25 inch+/−0.05 inch to allow the upper intestine to travel as it remains attached to the gizzard retained in the upper guide rail. The liver can then be powered through a decline, for example about approximately 10-35 degrees where the remaining upper intestine is pulled through the upper opening allowing the lungs spleen and bile sack to be pulled away from the liver through the opening slot or strip down gap. At the end of the module a rotary cutting blade can be utilized to separate the liver and heart from the remaining viscera pack. The heart and liver can now be removed to an inspector belt for grading.

An alternative embodiment can include proximately spaced apart counter rollers each having an endless belt traveling over said rollers whereby the belts convey inward one toward the other and can be sloped inward with respect to each other to converge at the nip line between the rollers. The belts can be sloped inward to properly position the viscera and direct the bottom portion toward the hip line. In this alternative embodiment, the belt and rollers can create an infeed belt assembly combination that can be utilized in lieu of the infeed pinch rollers.

The present invention increases the yield and quality significantly. These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a side view of an overhead rail and dual blade cutter assembly;

FIG. 2 is a bottom view of an overhead rail and dual blade cutter assembly;

FIG. 3 is a top view of an overhead rail and dual blade cutter assembly;

FIG. 4 is a perspective view of one side of a blade assembly;

FIG. 4a is a side view of one side of a blade assembly;

FIG. 4b is a front view of one side of a blade assembly;

FIG. 4c is a perspective view of the dual blade assembly;

FIG. 5 is a front left side perspective view of a liver and heart harvester assembly;

FIG. 6 is a right side view of a liver and heart harvester assembly;

FIG. 7 is a left side view of a liver and heart harvester assembly;

FIG. 8 is a front top left side view of a liver and heart harvester assembly;

FIG. 9 is a front right side view of a liver and heart stripper assembly;

FIG. 9A is a perspective view of an infeed pinch roller assembly and an infeed assembly;

FIG. 10 is a front left side view of a liver and heart stripper assembly;

FIG. 11 is a front right side perspective view of a pull down stripper assembly and a stripper arm assembly;

FIG. 12 is a cross section of a stripper arm assembly showing a strip down belt and indexers;

FIG. 13 is a side perspective view of a pull down stripper assembly;

FIG. 14 is a cross section of a pull down stripper assembly showing a pull down belt and indexers; and

FIG. 15 is an illustration of a giblet package;

FIG. 16 is a perspective view of an alternative embodiment liver and heart stripper assembly;

FIG. 17, is a perspective view of an alternative embodiment liver and heart stripper assembly; and

FIG. 17A is a perspective view of an infeed belt assembly and infeed assembly.

### DETAILED DESCRIPTION OF INVENTION

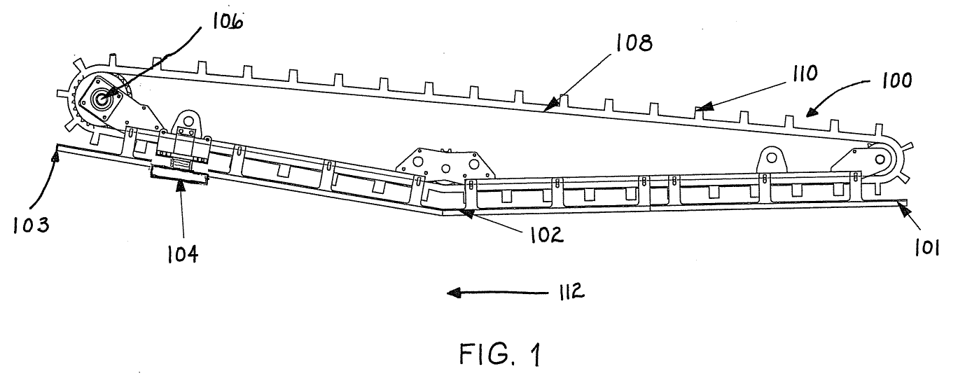

According to the embodiment(s) of the present invention, various views are illustrated in FIG. 1-17 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

### One Embodiment of the Present Invention

The details of the invention and various embodiments can be better understood by referring to the figures of the drawing. Referring to FIG. 1, a side view of an overhead rail and dual blade cutter assembly 100 is shown. The assembly 100 has an infeed end 101 adapted to receive a viscera pack, where the gizzard portion of the pack is received and conveyed above on top of the rail and a substantially larger portion of the intestine portion of the pack is received and hangs below the rail as it is being conveyed. The overhead rail 102 can comprise left and right rail portions that extend lengthwise in a substantially parallel manner, one with respect to the other, and having a lengthwise gap there between, and while remaining in a common plane, one with respect to the other along there lengths. The rail can be designed to receive the pack in such a manner that a substantial portion of the intestine hangs below the rail and a smaller portion of the intestine travels above atop the rail with the remainder of the pack.

The direction of conveyance of the pack is illustrated by arrow 112. The pack traverses from the infeed end 101 of the system to the discharge end 103 of the system. Forward conveyance of the pack is caused by the conveyor, which can have a conveyor chain 108 and a chain drive 106, where the chain has indexing members 110, which engage, index and urge the packs forward. As the chain 108 is driven by the drive 106, the indexing members 110, engage the pack and urge the pack forward toward engagement of the cutter assembly 104. The cutter assembly 104 can be positioned with the blades immediately below the rail such that it cuts away the substantially larger portion of the intestine hanging beneath the rail from the remainder of the pack, and only leaving a smaller portion of the intestine attached to the gizzard. The smaller portion of the intestine can be from about approximately 1 inch to about approximately 2 inches. In one embodiment of the invention, the discharge end portion of the rail can be adapted to angle upward thereby assisting the intestine separation.

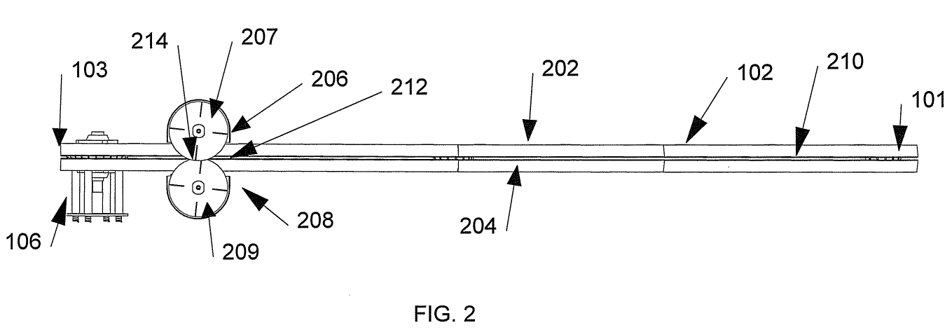

Referring to FIG. 2, a bottom view of an overhead rail and dual blade cutter assembly 100 is shown. The bottom view illustrates the left and right overhead rails, 202 and 204 respectively, with a substantially uniform gap 210 there between along there lengths. The bottom view also reveals the left and right cutter assemblies, 206 and 208 respectively. The left and right blades 207 and 209 are also shown. A portion of the intestine proximate the gizzard can be urged along the lengthwise gap 210 to engage the left-right blade interface 212. The left and right cutter assemblies can be mounted such that the edges of the blades slightly overlap, where the left blade 207 is positioned slightly above the right blade 209. The overlapping of the blades can provide for a cleaner cut for separating the intestine from the gizzard. The chain drive 106 is also shown in the view, which drives the chain, which engages and indexes the packs.

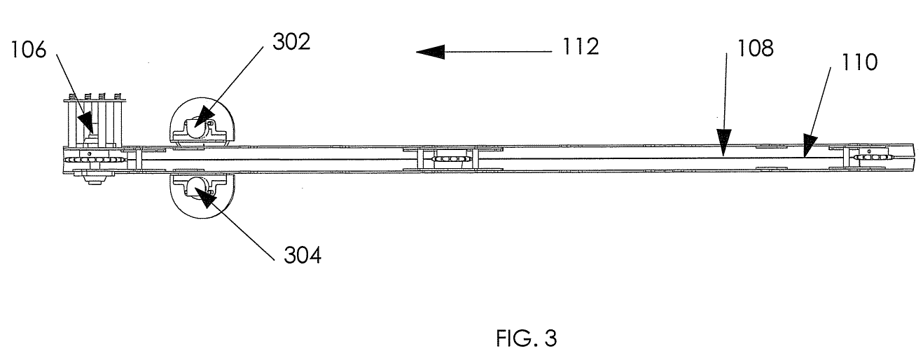

Referring to FIG. 3, a top view of an overhead rail and dual blade cutter assembly 100 is shown. The top view again illustrates the chain 108, the indexing members 110 and the drive 106. The left and right blade assembly drives 302 and 304 are also shown which drive the blades for cutting away the intestine from the gizzard. The flow of the product 112 is again illustrated by the direction arrow.

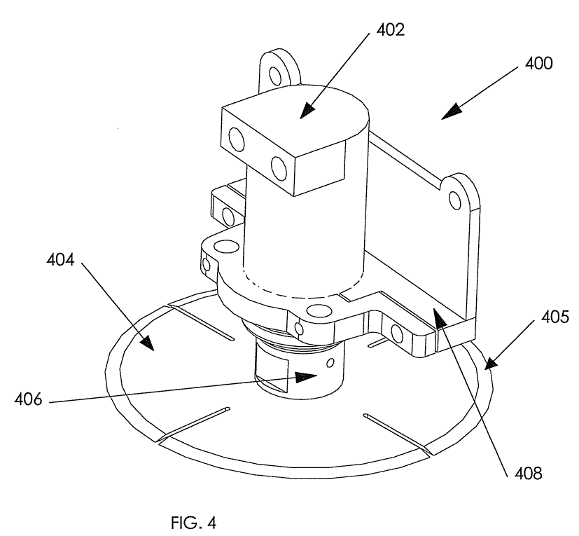

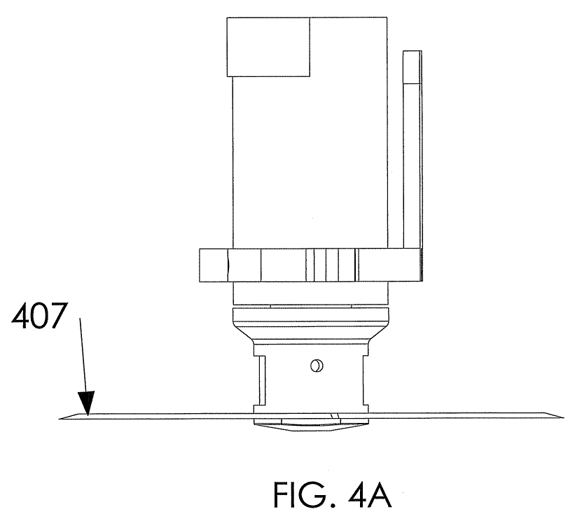

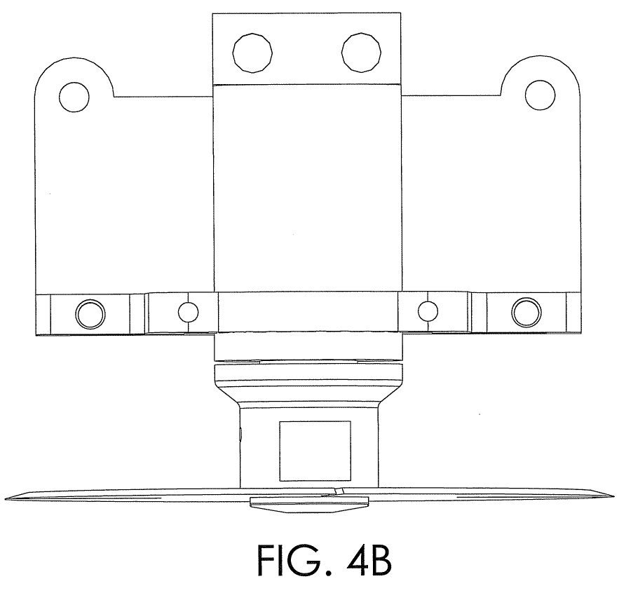

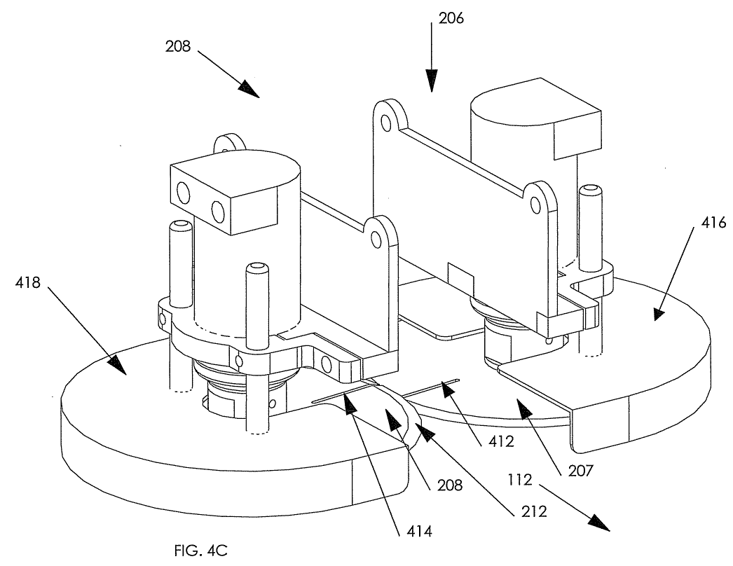

Referring to FIGS. 4, 4a, 4b, and 4c, FIG. 4 illustrates a perspective view of one side of a blade assembly; FIG. 4a illustrates a side view of one side of a blade assembly; FIG. 4b illustrates a front view of one side of a blade assembly; and FIG. 4c illustrates a perspective view of the dual blade assembly. A cutter assembly 400 is illustrated. The cutter assembly can be mounted to the overhead rail system using the mounting bracket 408. The mounting bracket 408 can be attached to the cutter drive 402 having a blade arbor 406 extending there from. The blade 404 as shown is a circular blade with a cutting edge 405 about its circumference. The arbor 406 can be rotatably driven by the cutter drive 402 to effect rotation of the blade, 404 attached to the arbor. FIGS. 4a and 4b further illustrate a cutter assembly 400. The blade 404 can have a bevel 407 to assist the cutting action. FIG. 4c illustrates the dual blade cutter assembly 104. The left and right cutter assemblies, 206 and 208 respectively, are illustrated as they could be mounted on opposing sides of the overhead rail assembly with the rail assembly positioned between the two mounting brackets. The dual blade cutter assembly is shown having left and right blade shields, 416 and 418. The blade interface 212 is shown with the left blade slightly above the right blade in a slightly overlapping fashion. The overlapping of the blades can provide for a clean and complete cut. Each blade is also shown having notches 412 and 414 in order to vent the blades and preventing snags.

As illustrated in the drawing, one embodiment of the apparatus for separating a substantial portion of the intestine for harvesting a gizzard from a poultry viscera comprises an overhead rail assembly having side by side left and right overhead rails extending from an infeed end to a discharge end along a path of conveyance. The left and right overhead rails can be configured to extend substantially in parallel one with respect to the other, and can be oriented to be proximately spaced apart forming a lengthwise substantially uniform gap there between said left and right overhead rails. The gap can have a dimension sufficiently narrow to prevent an upper portion of a viscera to pass through said gap while sufficiently wide to allow a small portion of an intestine proximate said gizzard to pass through said gap whereby a substantially larger portion of the intestine is maintained below the overhead rail assembly. For example the gap can be about approximately 0.3 inches, such as for example one embodiment can have a gap of about approximately 0.312 inches. An overhead indexing conveyor assembly can be utilized to advance the product whereby the conveyor can be vertically aligned above the overhead rail assembly.

The conveyor can be an indexing conveyor chain or belt or other reasonable substitute, with indexing members extending from said conveyor chain and oriented lengthwise along the path of conveyance and proximately above said overhead rail to urge the viscera along the over head rail. The indexing members can be sufficiently long to engage and advance the viscera. For example, the indexing members can be about approximately 2 inches and the members can be space apart an equidistance one with respect to the other and the spacing can be about approximately 4-6 inches depending on line speed and size of pack so that the viscera are adequately indexed.

A blade assembly can be positioned proximate the discharge end with the blade positioned immediately beneath the overhead rail and adapted to severe any of the intestine hanging below the overhead rail. Alternatively the blade can be positioned anywhere between the discharge end and the infeed end. The blade assembly can be designed to include a left and right cutter assembly mounted on opposing sides of the overhead rail assembly, one with respect to the other, where the left cutter assembly includes a left circular blade mounted on a left arbor rotatably mounted to a left drive and right cutter assembly can include a right circular blade mounted on a right arbor rotatably mounted to a right drive.

The left or right cutter assemblies are mounted such that one of the cutter assemblies is at a slightly higher elevation with respect to the other and such that the left and right circular blades overlap one with respect to the other. This is designed to provide for a consistent and reliable cut. Also, at least one of the left and right blades can have an elongated notch extending from the outer edge radially inward.

One embodiment of the method for harvesting usable parts from a poultry viscera comprises the steps of feeding a poultry viscera onto an overhead rail assembly having side by side left and right overhead rails extending from an infeed end to a discharge end along a path of conveyance, where said left and right overhead rails extend substantially in parallel one with respect to the other, and are proximately spaced apart forming a lengthwise substantially uniform gap there between said left and right overhead rails. The feeding step of the process can include allowing a small portion of an intestine proximate said gizzard to pass through said gap while maintaining a substantially larger portion of the intestine below the overhead rail assembly where said gap is sufficiently narrow to prevent an upper portion of a viscera to pass through said gap while sufficiently wide to receive the portion of the intestine proximate the gizzard.

A further step includes urging the viscera from the infeed end to the discharge end with an overhead indexing conveyor assembly vertically aligned above the overhead rail assembly and having an indexing conveyor chain with indexing members extending from said conveyor chain and oriented lengthwise along the path of conveyance and proximately above said overhead rail to urge the viscera along the over head rail. The step of cutting away the substantially larger portion of the intestine below the rail with a blade assembly positioned proximate the discharge end and having a blade positioned immediately beneath the overhead rail can be adapted to severe any the intestine hanging below the overhead rail while leaving a small portion attached to the gizzard to aid in further processing.

Yet another embodiment of the present invention includes another process stage comprising an infeed pinch roller assembly, a slide rail assembly, an overhead indexer conveyor assembly, an intestine pull down and a liver and heart stripper arm assembly teaches a novel apparatus and method for harvesting livers and hearts.

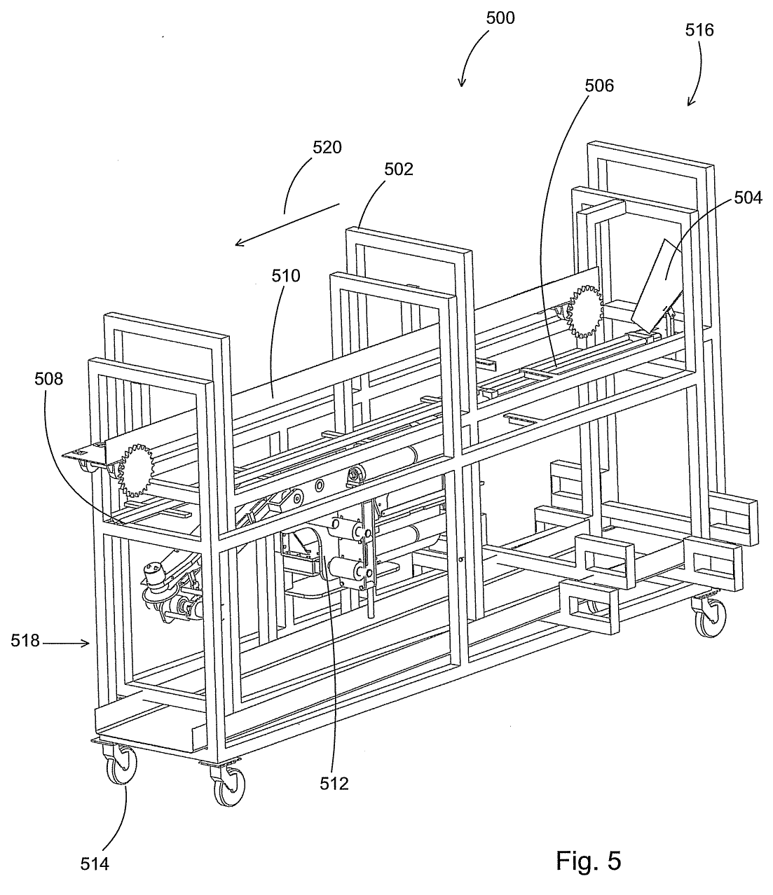

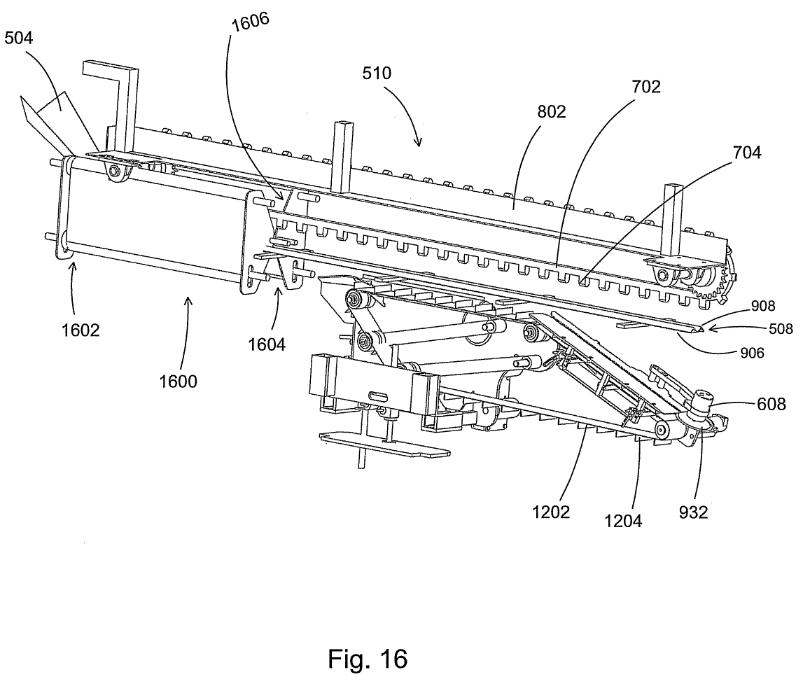

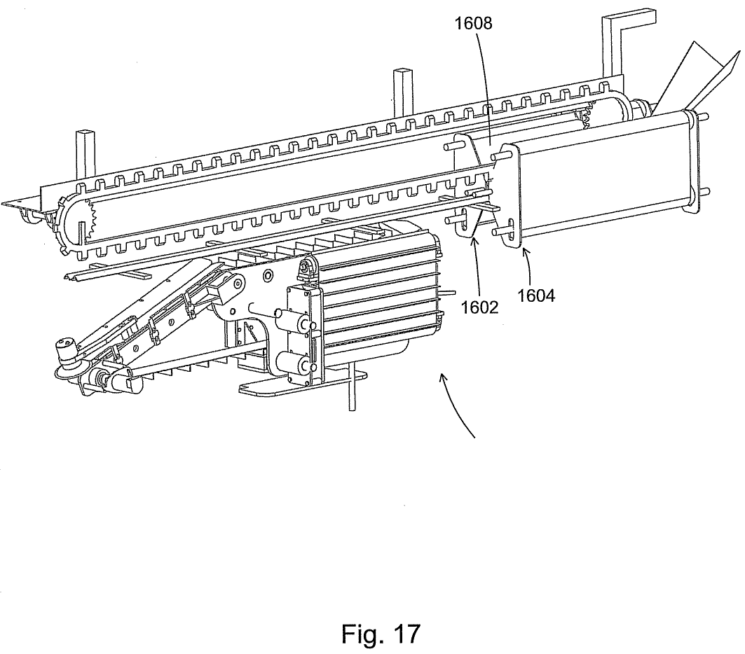

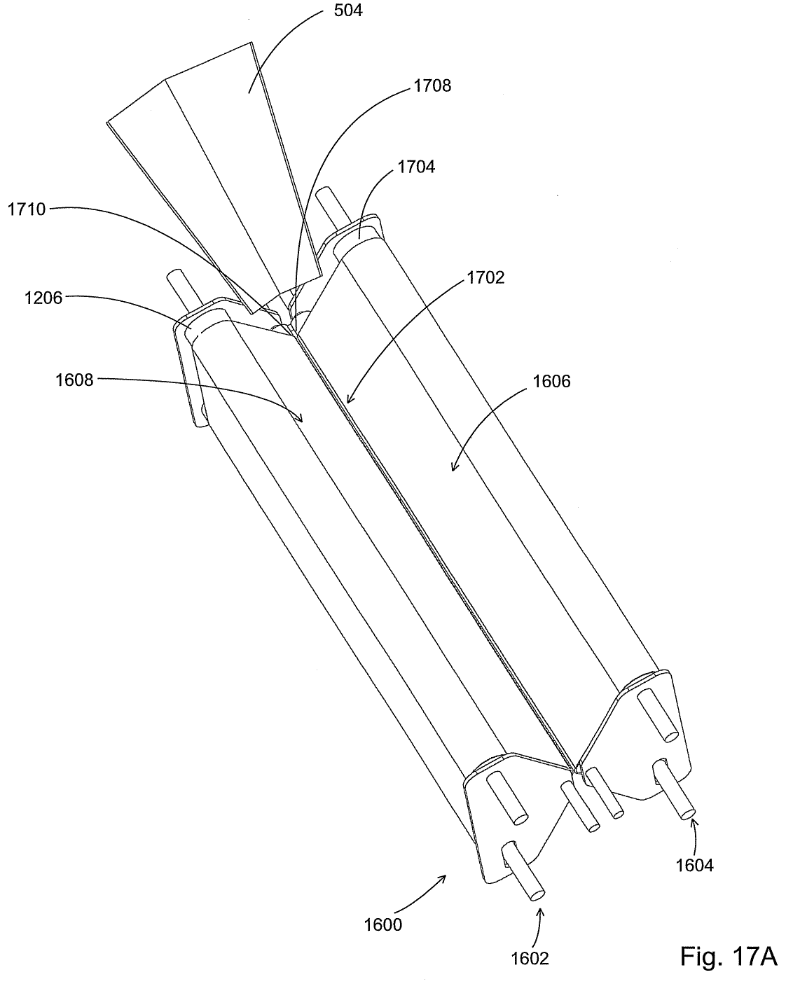

Referring to FIG. 5, a front left side perspective view of a liver and heart harvester assembly 500 is shown. The liver and heart harvester assembly 500 can be readily inserted in a poultry processing line for processing a viscera pack to remove usable parts such as for example the heart and liver. The liver and heart harvester assembly 500 is shown having a upstream entry end 516 and a downstream exit end 518. The viscera pack can be transversed along a path from the entry end 516 to the exit end 518 as indicated by arrow 520 showing the path of conveyance. Prior to being received by the liver and heart assembly 500, the viscera pack can be removed from the poultry carcass. Once removed, the viscera pack can be allowed to fall into the infeed assembly 504 having an infeed chute for channeling the viscera pack into the harvester system for further processing. The infeed assembly 504 can channel the viscera pack to engage the infeed pinch counter roller assembly 506. Also see the alternative embodiment as described in FIGS. 16 and 17 where the infeed pinch roller is replaced with an infeed belt assembly. The viscera pack is channeled to engage a pair of counter rollers turning into themselves in motion and spaced apart such that the viscera pack is forced into the rollers with only the gizzard portion of the viscera pack remaining on top of the roller body. The counter rollers can be sufficiently aggressive to pull all of the viscera pack therethrough with the exception of the gizzard portion. An overhead indexer conveyor assembly 510 can engage the viscera pack by engaging and pushing the gizzard portion along the length of the rollers to thereby exit the roller assembly 506 to engage a slide assembly 508.

The slide rail assembly 508 can have proximately spaced apart left and right v-shaped slide rails where the viscera pack can engage the slide rails by positioning the gizzard portion of the viscera pack to ride on top of the left and right slide rails and the remainder of the viscera pack hanging below the slide rails. The connection between the gizzard and the remainder of the viscera pack can be captured between the two v-shaped slide rails and the indexer assembly can continue to advance the viscera pack along the slide rails.

As the viscera pack is being advanced along the slide rails, the portion of the viscera pack containing the heart and the liver positioned below the slide rails can be engaged by a pull down back plate or a pull down bar or member which pulls or urges the pack downward by engaging the viscera in the liver area causing a downward motion downward away from the slide assembly and the gizzard portion. This step can be performed such that the pack membranes can be loosened and positioned in line for the next processing step. The overhead indexer assembly can further advance the viscera pack by engaging the gizzard portion to thereby engage the liver at heart stripper assembly 512 such that the heart and the liver portions of the viscera pack can be removed. A cutting device can be utilized to server the gizzard portion just prior the product exiting the harvest assembly at the exit end 518.

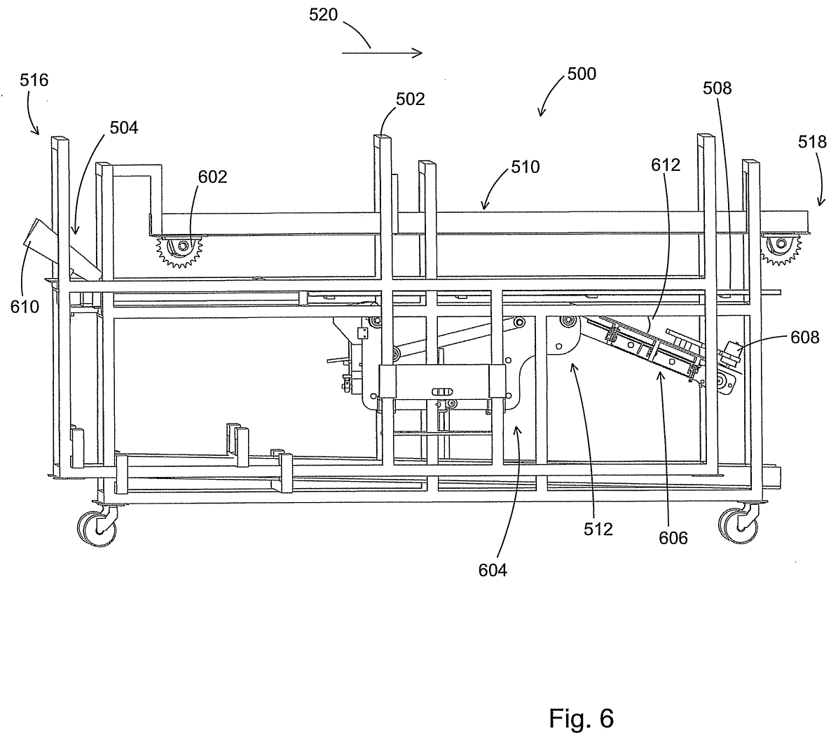

Referring to FIG. 6, a right side view of a liver and heart harvester assembly 500 is shown. The side view provides a more clear illustration of the path of conveyance 520 of the product as it travels from the entry end 516 to the exit end 518. The overhead indexer assembly 510 advances the product along the path of conveyance 520. The indexer assembly as shown in this side view is shown without the indexing belt 702 having indexers 704, which is discussed below. The indexer assembly 510 utilizes an indexing belt or chain to index the product and also advance the product along the path of conveyance 520. The indexing belt or indexing chain can be an endless belt or chain that is advanced by sprockets 602. The sprockets 602 can power the belt to advance the product along the path of conveyance for each step of the process.

This side view also shows the infeed assembly 504 having a chute 610 having a downward angle for channeling the product to engage the infeed pinch counter roller assembly. When the product engages the counter rollers as discussed above, the gizzard portion of the viscera remains on top of the rollers while the remainder of the viscera pack is below the rollers. The indexer assembly 510 utilizing the endless indexing belt engages the gizzard portion of the product to advance it through the rollers and then engage the slide assembly for directing the product along a path of conveyance to engage the pull down stripper assembly 604 and the strip down arm assembly 606 or stripper arm assembly and finally engage the cutter 608.

Prior to engaging the pull down stripper assembly 604, the product can engage a pull down back plate or pull down member which pulls the pack in the liver area in a downwards motion away from the slide rail assembly to thereby loosen the membranes of the viscera pack. The overhead indexer assembly 510 pushes the viscera pack along the slide rail assembly to engage the pull down stripper assembly which pulls the intestine downward and away from the slide rail and gizzard and pulls the intestine away from the liver. A blade or pull down cutter (not shown), such as for example, a motorized circular blade, can also be utilized at this stage to remove the excess intestine from the lower liver as the pack continues along the path of conveyance to the stripper arm assembly 606.

The indexer assembly 500 can further advance the pack to engage the stripper arm assembly 606 by engaging a strip down plate assembly where the remaining upper intestine is pulled through a length-wise gap allowing the lungs, spleen and bowel sack to be pulled away from the liver through the gap as the product is advanced along a downward decline along the stripper arm assembly. A cutter 608 can be utilized to separate the liver and heart from the remaining viscera pack. The heart and liver can now be removed for inspection and grading. The downward decline of the stripper arm assembly 606 can have a downward angle 612 that is about approximately 15 to 35 degrees in decline. The decline is effective to pull the lungs, spleen and bowel pack away from the liver by pulling it through the gap of the stripper arm assembly 606.

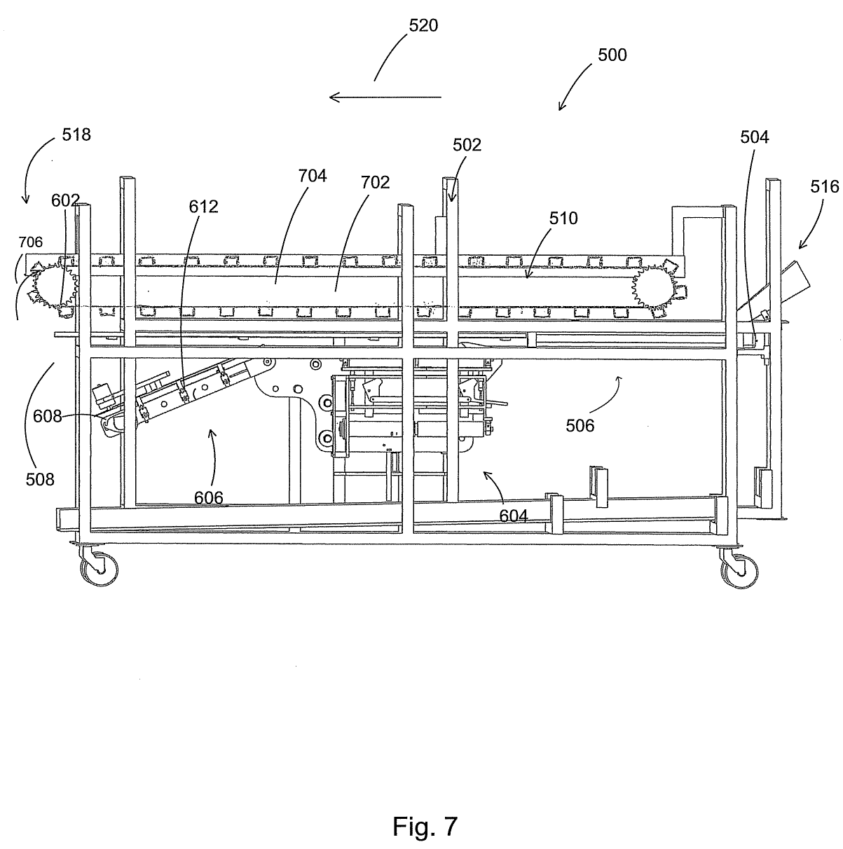

Referring to FIG. 7, a left side view of a liver and heart harvester assembly is shown. This view shows the opposing side of the liver and heart harvester assembly. This view also shows several of the primary components comprising the infeed assembly 504, the overhead indexer conveyor assembly 510, the pull down stripper assembly 604 and the stripper arm assembly 606. This illustration also provides an illustration of the indexer assembly 510 having an endless indexing belt 702 further comprising indexers 704 or indexer members. The indexing belt 702 can be powered by sprockets 602 by rotating in a direction as indicated by arrow 706. The indexing belt 702 can have evenly spaced apart indexers 704, which are utilized to engage and capture the gizzard portion of the viscera pack to advance the viscera pack along the path of conveyance as indicated by arrow 520.

The indexing belt 702 can be operable to adjust its speed such that the time of the belt is synchronized with the rate of the input of the viscera packs. The indexers 704 can index and advance the viscera pack along the path of conveyance to be processed by the infeed pinch counter roller assembly 506, the pull down stripper assembly 604, and the stripper arm assembly 606. As the viscera pack is advanced along the slide rail assembly 508 along the down stream portion of the slide rail assembly above the stripper arm assembly, the gizzard portion of the viscera pack can remain above the slide assembly while the liver section of the viscera pack is pulled downward along the stripper arm assembly 606 at an angle 612 with respect to horizontal such that the remaining upper intestine is pulled upward allowing the lungs and spleen and bowel pack to be pulled away from the liver through the stripping gap in the stripper arm assembly. At the end of the stripper arm assembly the cutter 608 can separate the liver and heart from the remaining viscera pack where the heart and liver can now be removed for inspection.

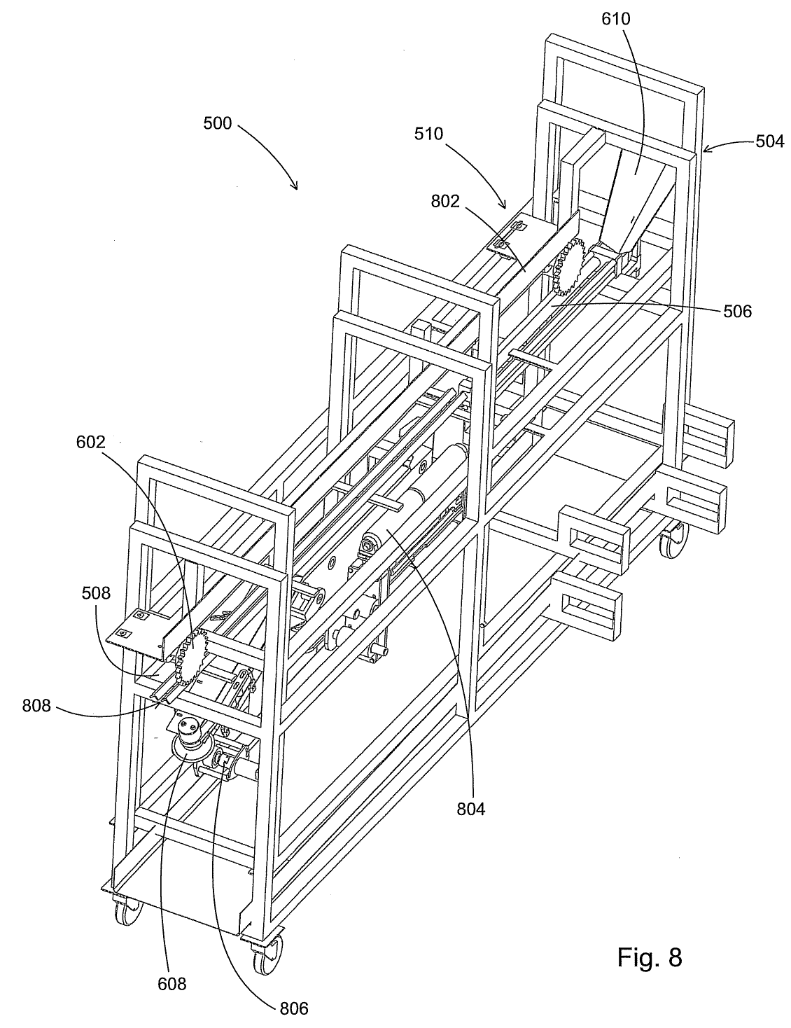

Referring to FIG. 8, a front top left side view of a liver and heart harvester assembly is shown. This view of the liver and heart harvester assembly 500 provides a better view of the infeed pinch counter roller assembly 506 and the slide assembly 508. The chute 610 of the infeed assembly 504 is shown with an orientation to channel the viscera product directly into the counter roller assembly 506. See the alternative embodiment described in FIGS. 16 and 17, which replaces the pinch roller. The counter roller assembly is shown below the overhead indexer assembly 510 having an indexer support bracket 802 for attaching the indexer assembly 510 to the frame at a position above the other components. The slide assembly 508 is shown in a downstream position along the path of conveyance with respect to the roller assembly 506. The slide assembly is shown comprising side by side v-shaped slide rails proximately spaced apart having a slide gap 808 there between.

The connective tissue of the viscera pack between the gizzard and the remaining portion of the viscera pack is allowed to travel along the gap in the slide assembly 508 as the gizzard of the viscera pack remains above and rides on top of the slide rail assembly while the remainder of the viscera pack is below the slide assembly. The indexer conveyor assembly advances the viscera pack from the roller assembly 506 to engage and travel on the slide assembly 508. The slide assembly 508 is designed to capture and retain the gizzard portion of the viscera pack while allowing the remainder of the viscera pack to hang below to thereby engage the pull down stripper assembly and the stripper arm assembly.

After the product engages the strip down plate assembly, the product is engaged by the portion of the pull down stripper assembly 604 having pull down rollers 804. The pull down rollers 804 can have a belt traveling thereon where said belt can have flap members extending there from to pull downward on the viscera pack to further separate the intestines. This view also reveals the strip bearing 806 of the stripper arm assembly 606, which is the bearing on which the strip down rollers are attached.

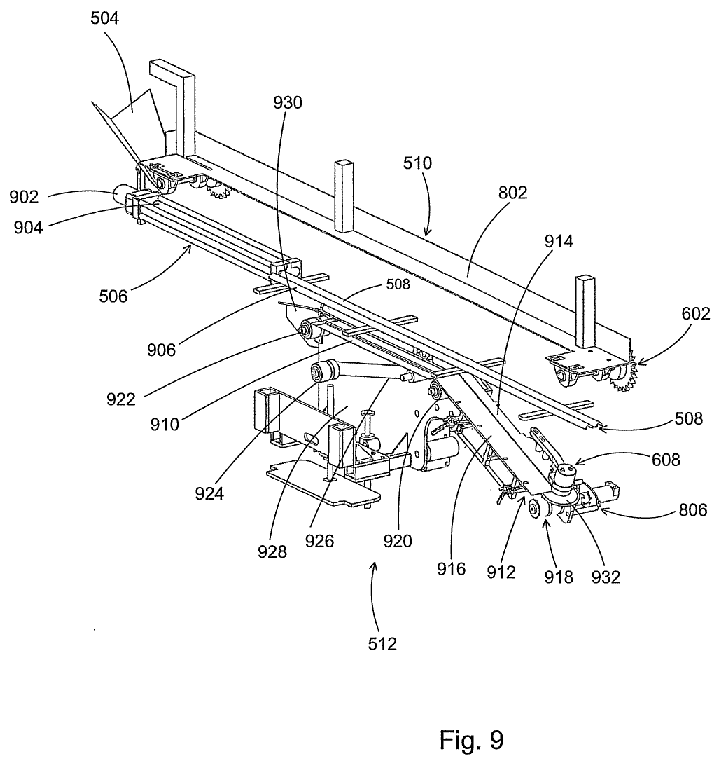

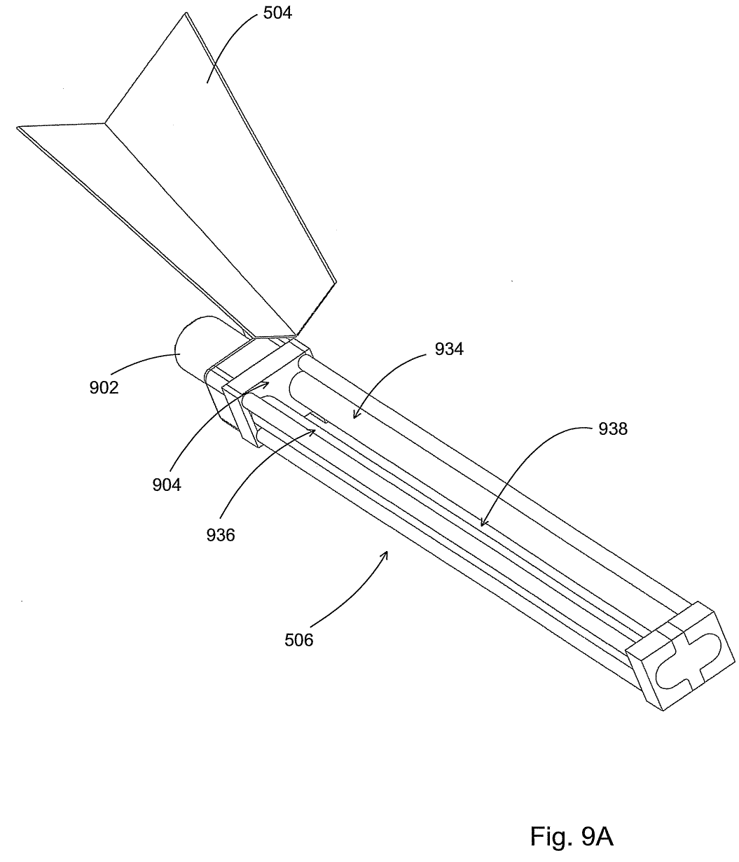

Referring to FIGS. 9 and 9A, a front right side view of a liver and heart stripper assembly is shown 512. This view shows the indexer assembly 510 disposed above the roller assembly 506, the slide assembly 508 where said slide assembly is disposed above the liver and heart stripper assembly 512. Again, the product is channeled by the infeed assembly 504 to engage the pinch rollers 904 of the roller assembly 506. The pinch rollers can be powered by a pinch roller motor 902. Again, the pinch rollers can be sufficiently aggressive to pull the viscera pack there through with the exception of the gizzard portion of the viscera pack. The indexer assembly can advance the pack to engage the slide assembly 508 which is shown having a right v-shaped slide rails 906 and a left v-shaped slide rail 908.

The pinch roller 904 includes left and right pinch rollers 934 and 936 respectively. The left and right rollers converge along a nip line 938. The space between the rollers 934 and 936 is sufficient to allow a portion of the viscera to pass there through.

The v-shaped slide rails are elongated slide rails having a v-shaped cross section. The vertex of the cross section of each bar is shown pointing upward thereby creating a valley between the slide rails 906 and 908. It is in this valley that the gizzard portion of the viscera pack can rest and be retained as it is being urged along the top surface of the slide rails. The left and right v-shaped rails are approximately spaced apart to allow passing through of the tissue connecting the gizzard of the viscera pack with the remaining portion of the viscera pack. Upon engaging and traveling on the upstream portion of the slide rail assembly 508, the viscera pack is engaged by a pull down back plate 930 which is designed to engage and pull downward on the viscera pack to further extend and loosen the membranes of the viscera pack. The pull down back plate can be a pull down bar or other member shaped to urge the liver area of the viscera downward when engaged.

This view also shows belt pan 910, roller 922, roller 924 and hold down arm 926. Rollers 922 and 924 and hold down arm 926 are for conveying and applying tension to the strip down belt conveyance. The pull down stripper assembly is shown having a back plate 928 for supporting the various members and for channeling the pack. As the viscera pack is advanced along the slide assembly 508, the viscera pack is engaged by the pull down stripper assembly 604 and is further advanced to the downstream end to engage the downward sloped stripper arm assembly 606 having a strip down plate assembly 912 further comprising a left strip down plate 914 and a right strip down plate 916. The strip down plates 914 and 916 are proximately spaced apart having a stripping gap there between along which connective tissue can travel and be pulled there through.

The downward angle of the stripper arm assembly 606 and more specifically the downward angle of the strip down plate 912 pulls downward on the viscera pack while the gizzard portion of the viscera pack remains above and travels along the topside of the slide rail assembly 108. The stripping gap between the strip down plates 912 and 914 is sufficiently wide to allow certain portions of the viscera pack to be pulled there through while sufficiently narrow to maintain the liver and heart portions of the viscera pack below the strip down plate assembly 912.

At the end of the strip down plate assembly 912 there can be a strip down cutter 608 having a blade 932 for severing the heart and liver portions from the portions of the viscera pack that were pulled upward through the gap between the left and right strip down plates. To further assist in this separation, the stripper arm assembly 606 can also include forward and rear strip down rollers 918 and 920. The strip down rollers can have an endless belt traveling thereon where said endless belt can have indexed strip down flaps for further assisting the pulling away of the liver and heart portions of the viscera pack and further indexing the various viscera packs being processed.

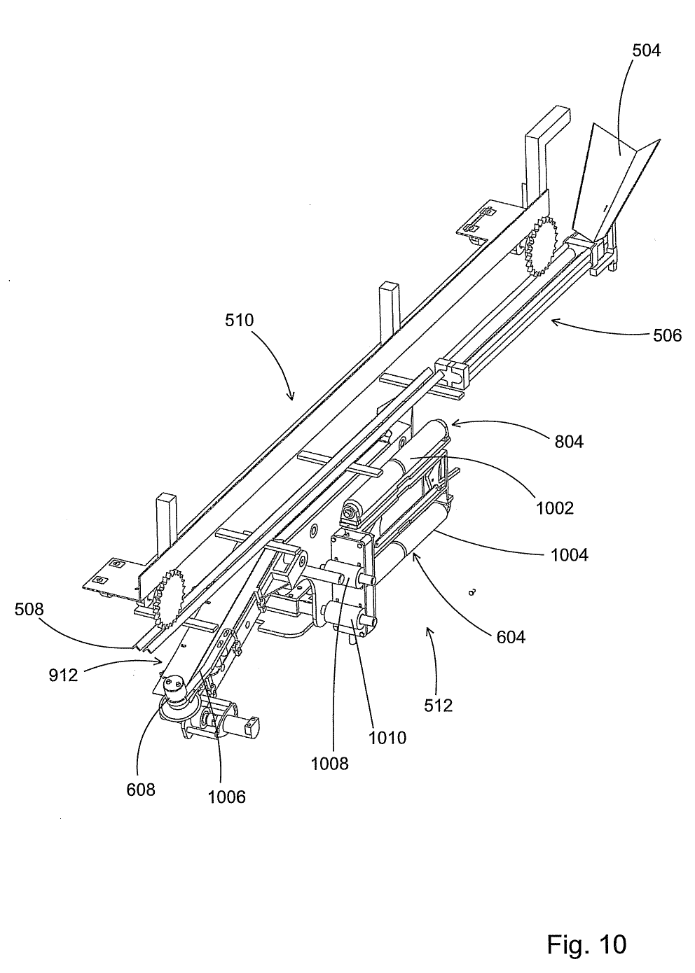

Referring to FIG. 10, a front left side perspective view of a liver and heart stripper assembly is shown. This view provides an alternative view of the same assembly thereby providing a better view of the pull down stripper assembly functionality. This view of the liver and heart stripper assembly 512 again is shown disposed below the indexer assembly 510. The pull down assembly 604 is shown having pull down rollers 804 which comprises an upper pull down idle roller 1002 and a lower pull down drive roller 1004. The idle and drive functions of the respective rollers can reverse functionality without departing from the scope of the invention. The upper and lower pull down roller 1002 and 1004 can have traveling thereon an endless belt having indexed flaps for pulling downward on the viscera pack to further separation. This view also reviews a motor arm mount for mounting a cutter 608 with respect to the strip down plate assembly 912. The motor arm mount 1006 can be adjustable to adjust the position of the cutter 608.

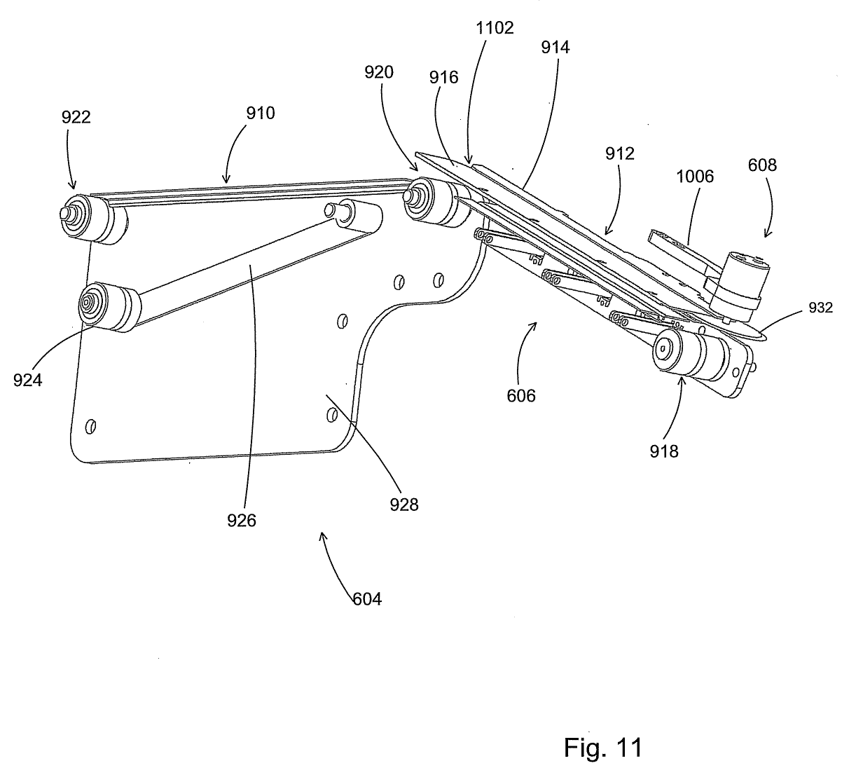

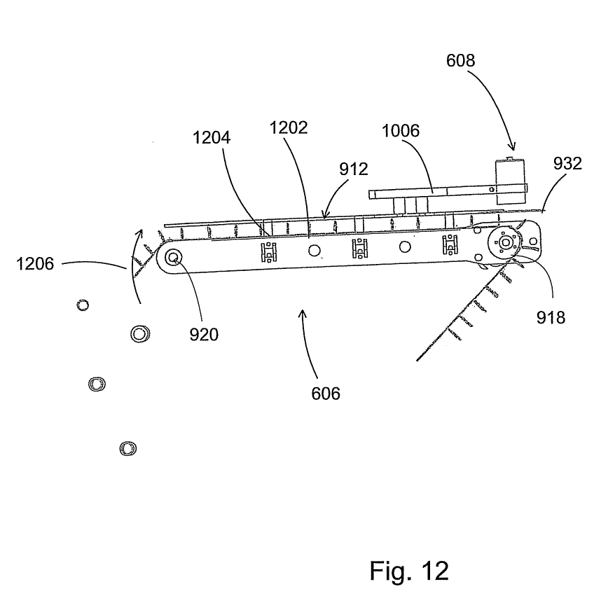

Referring to FIG. 11, a front right side perspective view of a pull down stripper assembly and a stripper arm assembly is shown. This view provides further clarity relating to the position of the stripper arm assembly 606 with respect to the pull down stripper assembly 604. The stripper arm assembly 606 is shown with a downward decline for separation of the heart and liver portions of the viscera pack. This view also provides a further illustration of the roller 922, a tension roller 924, a hold down tension arm 926 and a belt pan 910. The tension roller and tension arm can be utilized to increase and decrease tension in the belt. Roller 922 is a further roller over which the strip down belt travels as reflected in FIGS. 12, 16 and 17. A further view of the strip down rollers 920 and 918 is also shown. This view also provides further clarity of the stripping gap 1102 between the right and left strip down plates 914 and 916 of the strip down plate assembly 912.

Referring to FIG. 12, a cross section of a stripper arm assembly showing a strip down belt and indexers is shown. This cross section the stripper arm assembly 606 provides an illustration of the relationship between the strip down plate assembly 912 and the cutter 608 including blade 932. This cross section view also provides an illustration of the strip down belt 1202 having strip down indexers 1204 which further facilitates the separation of the liver and heart from the remainder of the viscera pack. The forward and rear strip down rollers 918 and 920 can have the strip down belt traveling thereon such that the strip down belt is powered in a direction as indicated by arrow 1206. The strip down indexers 1204 can index the hearts and livers of the viscera packs as well as assist in pulling the heart and liver away from the remainder of the viscera pack.

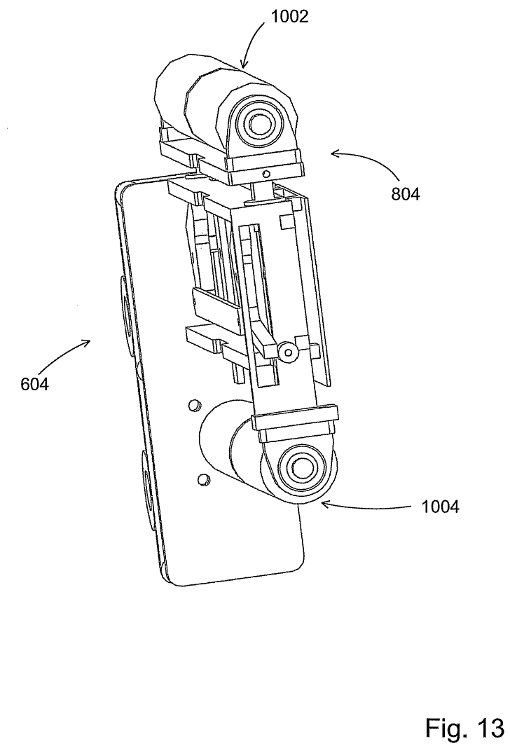

Referring to FIG. 13, a side perspective view of a pull down stripper assembly is shown. This figure provides a view of the pull down rollers 804 comprising the upper pull down idle roller 1002 and the lower pull down roller 1004. This view of the pull down roller assembly 604 further illustrates its functionality.

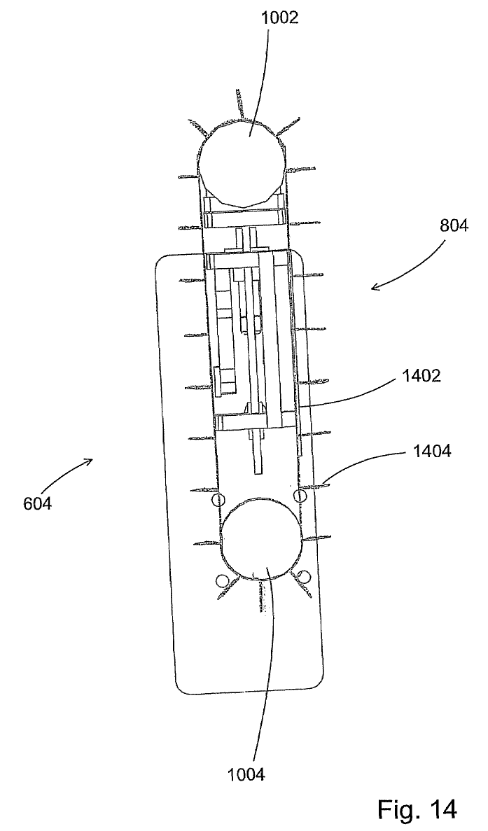

Referring to FIG. 14, a cross section of a pull down stripper assembly showing a pull down belt and indexers is shown. This cross section view of the pull down stripper assembly 604 includes an illustration of a pull down belt 1402 comprising a plurality of pull down belt indexed flaps 1404 where the pull down belt travels about the pull down rollers comprising the upper pull down idle roller 1002 and the lower pull down drive roller 1004. The indexed flaps 1404 can assist in pulling downward on the viscera pack.

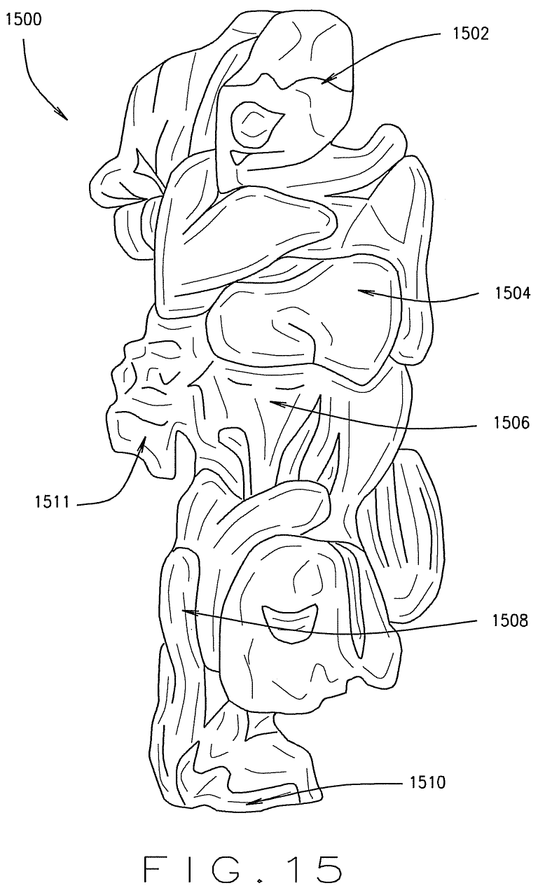

Referring to FIG. 15, what can be referred to as a giblet package 1500 is shown comprising a gizzard 1502, a liver and gall 1504, heart 1506, intestines 1508, vent 1510 and lungs 1511.

Referring to FIGS. 16 and 17 a perspective view of an alternative embodiment liver and heart stripper assembly is shown. Again shown is the overhead indexer conveyor assembly 510, including the indexer support bracket 802, indexing belt 702 and indexers. The slide assembly 508 is also shown including left and right slide bars 908 and 906. The cutter 608 and the blade 932 is also shown. A more complete view of the strip down belt 1202 including the strip down indexers 1204 is shown. The difference in this embodiment is where the infeed assembly 504 feeds the inward feeding belt assembly 1600. The infeed belt assembly 1600 includes proximately spaced apart left and right inward feeding belts 1604 and 1602. The left and right inward feeding belts are configured such that each endless belt travels over three rollers 1704, 1708 and a third roller not shown in this view for the left belt and 1706, 1710 and a third belt not shown for the right belt thereby creating a triangular path of travel. The belts convey inwardly and opposite with respect to one another. The upper portion of the inside run 1608 and 1606 of each belt is directed inward one toward the other forming a v-shaped channel for urging a viscera pack downward similar to the rollers described in the previous embodiment. Rollers 1708 and 1710 are similar to the pinch roller embodiment but in this embodiment a belt travels over the rollers to converge along a nip line 1702 formed by rollers 1708 and 1710 and the belt traveling over said rollers. The inside or inward runs 1606 and 1608 slope inward with respect to each other to converge a long a nip line. Below the nip line the belts diverge outward with respect to each other such that viscera portions pulled below the nip line is not continuously pulled downward by the belts.

Once removed, the viscera pack can be allowed to fall into the infeed assembly 504 having an infeed chute for channeling the viscera pack into the harvester system for further processing. The infeed assembly 504 can channel the viscera pack to engage the inward infeed belt assembly 1600. The viscera pack is channeled to engage a pair of inward feeding belts conveying inward toward themselves in motion and spaced apart such that the viscera pack is forced into the inward feeding belts with only the gizzard portion of the viscera pack remaining on top of the top portion of the v-shaped inside run of the inward infeed belts. The inward infeed belts can be sufficiently aggressive to pull all of the viscera pack there through with the exception of the gizzard portion. An overhead indexer conveyor assembly 510 can engage the viscera pack by engaging and pushing the gizzard portion along the length of the rollers to thereby exit the roller assembly 506 to engage a slide assembly 508.

The various liver and heart harvesting apparatus examples shown above illustrate a novel method for harvesting livers and hearts with increased quality and yield. A user of the present invention may choose any of the above harvester embodiments, or an equivalent thereof, depending upon the desired application. In this regard, it is recognized that various forms of the subject harvester invention could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. An apparatus for separating a substantial portion of the intestine for harvesting a gizzard from a poultry viscera comprising:
an overhead rail assembly having side by side left and right overhead rails extending from an infeed end to a discharge end along a path of conveyance, where said left and right overhead rails extend substantially in parallel one with respect to the other, and are proximately spaced apart forming a lengthwise substantially uniform gap there between said left and right overhead rails, and where said gap is sufficiently narrow to prevent an upper portion of a viscera to pass through said gap while sufficiently wide to allow a small portion of an intestine proximate said gizzard to pass through said gap whereby a substantially larger portion of the intestine is maintained below the overhead rail assembly;
an overhead indexing conveyor assembly vertically aligned above the overhead rail assembly and having an indexing conveyor chain with indexing members extending from said conveyor chain and oriented lengthwise along the path of conveyance and proximately above said overhead rail to urge the viscera along the over head rail; and
a blade assembly positioned proximate the discharge end and having a blade positioned immediately beneath the overhead rail and adapted to severe any the intestine hanging below the overhead rail.

2. The apparatus as recited in claim 1, where the blade assembly includes a left and right cutter assembly mounted on opposing sides of the overhead rail assembly, one with respect to the other, where the left cutter assembly includes a left circular blade mounted on a left arbor rotatably mounted to a left drive and right cutter assembly includes a right circular blade mounted on a right arbor rotatably mounted to a right drive.

3. The apparatus as recited in claim 2, where the left or right cutter assemblies are mounted such that one of the cutter assemblies is at a slightly higher elevation with respect to the other and such that the left and right circular blades overlap one with respect to the other.

4. The apparatus as recited in claim 2, where at least one of the left and right blades have an elongated notch extending from the outer edge radially inward.

5. The apparatus as recited in claim 2, where a portion of the left and right overhead rails on the discharge end of the overhead rails has an upward incline and the blade assemblies are mounted such that the circular blades have a comparable incline.

6. The apparatus as recited in claim 5, where the conveyor chain is an endless conveyor chain traveling over an infeed end sprocket and a discharge end sprocket distal with respect to the infeed end sprocket and a middle sprocket positioned between said discharge end sprocket and said infeed end sprocket along the path of conveyance and where said discharge end sprocket is positioned at a higher vertical elevation with respect to the middle sprocket creating a slightly upward incline in the endless conveyor chain.

7. The apparatus as recited in claim 6, where the indexing members are a plurality of lugs attached along the length of the endless conveyor chain and spaced apart an equidistance one with respect to the other and orthogonally extending from said endless conveyor chain.

8. The apparatus as recited in claim 2, further comprising:
an upper chute oriented proximate the discharge end of said overhead rail assembly and adapted to channel the upper portion of the viscera in a first direction for further processing; and
a lower chute oriented and vertically aligned below the cutter assembly adapted to channel the larger portion of the intestine in a second direction for further processing.

9. An apparatus for harvesting usable parts from a poultry viscera comprising:
an overhead rail assembly having side by side left and right overhead rails extending from an infeed end to a discharge end along a path of conveyance, where said left and right overhead rails extend substantially in parallel one with respect to the other, and are proximately spaced apart forming a lengthwise substantially uniform gap there between said left and right overhead rails, and where said gap is sufficiently narrow to prevent an upper portion of a viscera to pass through said gap while sufficiently wide to allow a small portion of an intestine proximate said gizzard to pass through said gap whereby a substantially larger portion of the intestine is maintained below the overhead rail assembly;
an overhead endless indexing chain conveyor vertically aligned above the overhead rail assembly and oriented lengthwise along the path of conveyance and proximately above said overhead rail and adapted to urge the viscera along the over head rail; and
a blade assembly positioned between the discharge end and the infeed end and having a blade positioned immediately beneath the overhead rail and adapted to severe any the intestine hanging below the overhead rail.

10. The apparatus as recited in claim 9, where the blade assembly includes a left and right cutter assembly mounted on opposing sides of the overhead rail assembly, one with respect to the other, where the left cutter assembly includes a left circular blade mounted on a left arbor rotatably mounted to a left drive and right cutter assembly includes a right circular blade mounted on a right arbor rotatably mounted to a right drive.

11. The apparatus as recited in claim 10, where the left or right cutter assemblies are mounted such that one of the cutter assemblies is at a slightly higher elevation with respect to the other and such that the left and right circular blades overlap one with respect to the other.

12. The apparatus as recited in claim 10, where at least one of the left and right blades have an elongated notch extending from the outer edge radially inward.

13. The apparatus as recited in claim 10, where a portion of the left and right overhead rails on the discharge end of the overhead rails has an upward incline and the blade assemblies are mounted such that the circular blades have a comparable incline.

14. A method for harvesting usable parts from a poultry viscera comprising the steps of:
feeding a poultry viscera onto an overhead rail assembly having side by side left and right overhead rails extending from an infeed end to a discharge end along a path of conveyance, where said left and right overhead rails extend substantially in parallel one with respect to the other, and are proximately spaced apart forming a lengthwise substantially uniform gap there between said left and right overhead rails, and where feeding includes allowing a small portion of an intestine proximate said gizzard to pass through said gap while maintaining a substantially larger portion of the intestine below the overhead rail assembly where said gap is sufficiently narrow to prevent an upper portion of a viscera to pass through said gap while sufficiently wide to receive the portion of the intestine proximate the gizzard;
urging the viscera from the infeed end to the discharge end with an overhead indexing conveyor assembly vertically aligned above the overhead rail assembly and having an indexing conveyor chain with indexing members extending from said conveyor chain and oriented lengthwise along the path of conveyance and proximately above said overhead rail to urge the viscera along the over head rail; and
cutting away the substantially larger portion of the intestine below the rail with a blade assembly positioned proximate the discharge end and having a blade positioned immediately beneath the overhead rail and adapted to severe any the intestine hanging below the overhead rail.

15. The method as recited in claim 14, where cutting away is cutting with the blade assembly including a left and right cutter assembly mounted on opposing sides of the overhead rail assembly, one with respect to the other, where the left cutter assembly includes a left circular blade mounted on a left arbor rotatably mounted to a left drive and right cutter assembly includes a right circular blade mounted on a right arbor rotatably mounted to a right drive.

16. The method as recited in claim 14, further comprising the steps of:
mounting one of the cutter assemblies is at a slightly higher elevation with respect to the other and such that the left and right circular blades overlap one with respect to the other.

17. The method as recited in claim 14, further comprising the steps of:
channeling the upper portion of the viscera in a first direction with an upper chute oriented proximate the discharge end of said overhead rail assembly for further processing; and
channeling the larger portion of the intestine in a second direction with a lower chute oriented and vertically aligned below the cutter assembly for further processing.

18. The method as recited in claim 14, where cutting away is cutting substantially all of the intestine away except for a small portion.
